(19) United States
(12) Patent Application Publication
(10) Pub. No.: US 2020/0124488 A1
(43) Pub. Date: Apr. 23, 2020

(54) Brake Fluid Detection System

(71) Applicant: PEACEFUL THRIVING ENTERPRISE CO., LTD., Changhua County (TW)

(72) Inventor: Shih-Hsiang Chien, Changhua County (TW)

(21) Appl. No.: 16/719,842

(22) Filed: Dec. 18, 2019

Related U.S. Application Data
(63) Continuation-in-part of application No. 15/686,141, filed on Aug. 24, 2017.

(51) Int. Cl. G01L 5/22; B60T 17/22; B60T 8/88

(52) U.S. Cl. CPC G01L 5/225; F16D 66/021; B60T 8/885; B60T 17/22

(57) ABSTRACT

A brake fluid detection system used for detecting the brake fluid quality of a brake device is revealed. The detection system includes a first device having a detection unit connected to a data transmission unit, a second device composed of a data storage unit, a data analysis unit, and a data processing unit, and a third device provided with an application software. The data transmission unit is provided with a wireless communication module. The third device is a portable internet device. The third device receives detected data obtained and uploaded by the first device and users set the detected data by operating the application software. Then the original detected data and the detected data set by users is sent to the data processing unit of the second device through a wireless network for data processing to get detection data. Lastly detection data is displayed on the third device.

### CROSS REFERENCE OF RELATED APPLICATION

This is a Continuation-In-Part application that claims the benefit of priority under 35 U.S.C. § 120 to a non-provisional application, application Ser. No. 15/686,141, filed Aug. 24, 2017.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a brake fluid detection system, and more particularly to a brake fluid detection system that uses mobile internet devices, such as tablets or cell phones, to detect quality data of the brake fluid detected, to connect to the cloud database for data processing and analysis, and to display the detection results for the user through the mobile internet devices.

### Description of Related Arts

Generally, a vehicle brake system is filled with brake fluid. Brake fluid is a type of hydraulic fluid used in hydraulic brake and hydraulic clutch applications in various vehicles. When a driver steps on the brake pedal, the stepping force applied to the pedal will be transmitted to the brake system of the vehicle through the brake fluid. When we press on the brake pedal, with the aid of a vacuum booster, the brake master cylinder is driven to exert pressure on the brake fluid and send the brake fluid to four wheel cylinders (one for each wheel). The brake cylinders receive the brake fluid and push the brake pads against the brake discs, resulting in the braking force required. However, the brake fluid starts to absorb moisture since it is filled into the brake system. Thus the brake performance will be affected if the brake fluid is not replaced periodically and cause dangerous situations on the rod. The moisture in the brake fluid can lower the boiling point of the brake fluid, resulting in insufficient braking pressure and reduced braking effect.

When the brake system works, heat generated by the friction between brake pads and the brake discs causes the temperature of the system to rise. Once the temperature reaches the boiling point, the water content in the brake fluid is boiling and bubbles are going up. A certain amount of air entering the brake pipeline will cause inadequate brake force because the air is compressible and the brake failure may occur if the case is serious.

Thus people in the business have developed a device with a test probe. The water content in the brake fluid can be measured by the test probe being immersed into the brake fluid tank. The data detected through electronic circuit is processed and analyzed by the processor in the device to find out the test results.

However, there are different types of brake fluid. Even the same type of brake fluid may have different parameters in determining the quality of the brake fluid due to differences in ingredients. Hence there is a need to expand the database of the processor for improving the versatility of the product. Yet the cost and the volume of the device are increased along with the database expansion. Another issue to be considered is that certain users may not understand how to update the database. Thus the device can provide the most up-to-date large database with original cost and volume if the database is set up in the clouds, maintained and updated by manufacturers or dealers. At the same time, there is no more need for users to worry about the trivia database update.

Refer to U.S. Pat. No. 5,239,486, a brake testing device is revealed. The brake testing device includes a central processing unit CPU 10, a monitor 20, a keyboard for data entry 30, a micrometer 40, a hydrometer 50 and a torque wrench 60. As shown in the figures, the electronic caliper 40, the hydrometer 50, or the torque wrench 60 is connected to the central processing unit CPU 10. The central processing unit 10 is programmed with a variety of operating systems that are able to receive the inputs from the keyboard 30, the electronic caliper 40, the electronic hydrometer 50, or the electronic torque wrench 60 and display the results of such inputs as well as outputs from the central processing unit 10 on the monitor 20. It is obvious that the testing device is unable to be moved freely for detecting objects to be tested. The objects can only be detected within a certain range due to the limited length of the solid wire. All data in files is stored in the database in memory of the CPU 10. Thereby only the CPU 10 performs data storage, data processing and displaying data (data display). Both the monitor 20 and the keyboard 30 are fixed on a certain position, unable to move and are connected to the testing device by the solid wires. That means a data processing center is corresponding to a set of the keyboard and the test end.

Refer to US Pat. App. No. 20180148068, a system of a vehicle for modifying a performance of a vehicle component whose performance is affected by a vehicle fluid that is contaminated by water and a method for the same are revealed. The vehicle fluid is selected from a group that consists of: engine oil, brake fluid, fuel, power steering fluid and transmission fluid. The vehicle component is selected from a group that consists of: an engine; a brake; a brake line; a fuel injector; a fuel line; a power steering unit; and a transmission. An advanced driver assistance system (ADAS) included therein is a vehicular system that is operable to perform or control a performance of one or more of a plurality of vehicle functions. The display panel of the ADAS system of the present system is fixed in the vehicle while a detection end of the system is coupled to automotive electronics via solid lines. Thus the system is fixed, unable to be moved to another automobile for testing.

### SUMMARY OF THE PRESENT INVENTION

Therefore it is a primary object of the present invention to provide a brake fluid detection system used in which a portable detection device is used in combination with a cloud database and a portable internet device, allowing users to access brake fluid related data in a real-time manner. The cost of data storage is significantly reduced due to rapid development and progress of the modern cloud computing and communication technology. By means of computing and communication on the clouds, data of various types of the brake fluid is stored in the cloud database by the present brake fluid detection system. Detected data received via a wireless network is processed by cloud computing and then is transmitted to a portable internet device where operations are performed and detection data obtained is displayed. Thereby the present system not only provides a more-precise massive database but also portability and easy operation.

In order to achieve the above object, a brake fluid detection system designed for detecting the quality of brake fluid according to the present invention is composed of a first device, a second device and a third device.

The first device consists of a detection unit and a data transmission unit with a wireless communication module. The first device is a detection device corresponding to objects to be detected. The detection unit is in direct contact with the objects to be detected to get detected data. The data transmission unit is connected to the detection unit for receiving the detected data and sending data to the third device by the wireless communication module through a wireless connection. The third device which is arranged with an application software and an operation interface is used for sending the data to the second device via a wireless network. The second device is composed of a data storage unit, a data analysis unit, and a data processing unit. The data transmission unit sends the detected data to the third device and the detected data is obtained through the detection in the fluid tank by the detection unit. Then users can define parameters required for detection of the brake fluid by the operation interface of the application software. The parameters hereafter are called data set by users. According to the detected data from the first device and the data set by users from the third device, the data analysis unit of the second device retrieves brake fluid related data in the data storage unit and provides the brake fluid related data to the data processing unit for analyzing. Then the data processing unit generates detection data which is provided and sent to the third device for users to view.

The second device can be a cloud database while the application software of the third device is corresponding to the detected data of the first device and responsible for transmitting the detected data to the second device. The second device is not only used for storage of a large amount of brake fluid related data but also for receiving and analyzing the detected data of the detection unit. The data processing unit is connected to the data storage unit and used for processing the detected data from the first device and comparing the detected data with the brake fluid related data in the data storage unit to generate detection data. Then the detection data is displayed on the third device for users to view.

The second device gets data set by users from the user end through the third device to learn the type and the brand of the brake fluid to be detected for finding out the brake fluid related data corresponding to the type and the brand of the brake fluid to be detected. The data processing unit and the data analysis unit of the second device also receives the detected data obtained by the first device through the third device. The data analysis unit performs analysis of the detected data first. Then the data processing unit processes the detected data and compares the detected data with the brake fluid related data in the database to get detection results. The detection results are sent back to the third device and the detection data is displayed on the operation interface of the third device for users to read.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of the structure of an embodiment according to the present invention;

FIG. 2 is a perspective view of an operation interface of an embodiment according to the present invention.

### DETAILED DESCRIPTION OF THE PREFERRED EMBODIMENT

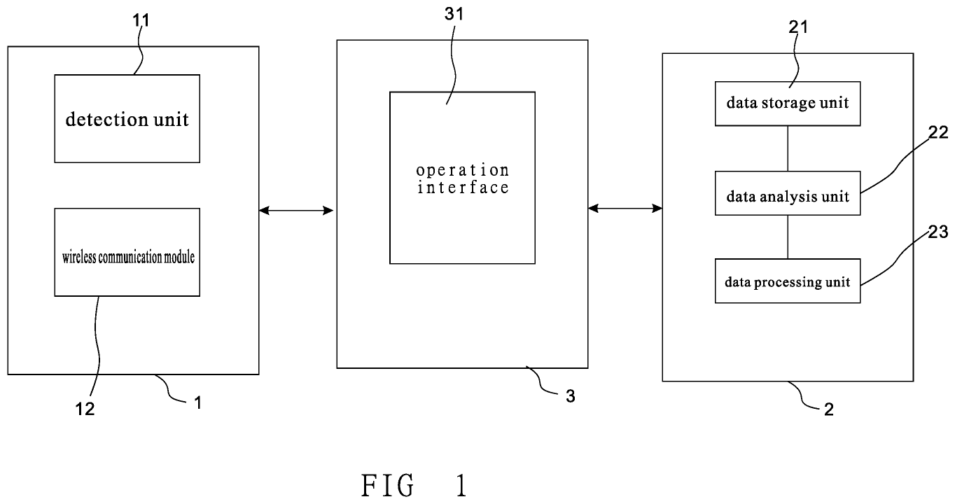

As shown in FIG. 1, a brake fluid detection system according to the present invention includes a first device 1, a second device 2 and a third device 3. The first device 1 consists of a detection unit 11 and a data transmission unit connected to each other. The data transmission unit is provided with a wireless communication module 12 which is used to provide a wireless connection for sending and receiving data. The detection unit 11 is a probe arranged with a sensing circuit and in direct contact with a brake fluid to be detected for sensing changes in water content or temperature of the brake fluid.

The second device 2 is a cloud database composed of a data storage unit 21, a data analysis unit 22, and a data processing unit 23.

The third device 3 is a portable internet device (such as a cell phone or a tablet) provided with an application software which is used for receiving and displaying data of the brake fluid after detection and having an operation interface 31. The wireless communication module 12 receives detected data obtained through the detection in the fluid tank by the detection unit 11 and sends the detected data to the third device 3 through the wireless connection. Then the detection data is further transmitted to the second device 2 through the third device 3 for data extraction and processing. By operating the operation interface 31, the third device 3 is connected to the first device 1 and the second device 2 correspondingly via the wireless network. The third device 3 is defined to be used as the device for data transmission and operation between the first device 1 and the second device 2 as well as data display. The operation interface 31 of the third device 3 is interactively connected to the detection unit 11 of the first device 1 for getting the detected data and is operated for sending the detected data to the second device 2. Brake fluid related data has been set and stored in the data storage unit 21 of the second device 2 in advance. The brake fluid related data includes types of the brake fluid, oil companies/brands, experimental data for the respective brake fluids, water content, etc. The data analysis unit 22 retrieves the brake fluid related data in the data storage unit 21 together with data set by users received and performs analysis. Then the data processing unit 23 generates the detection data. Next the detection data is obtained by and displayed on the third device 3 so that users can check the detection data in a real-time manner.

More specifically, the third device 3 is connected to the first device 1 through the wireless connection for getting the detected data and sending the detected data to the second device 2 over the wireless network. The application software of the third device 3 is provided with an operation interface 31 which has a display screen. To put it another way, when the application software is launched, users can perform the operations on the operation interface 31 of the third device 3 which is connected to the first device 1 and the second device 2 for interactively receiving and sending data at the same time.

The application software is preset in the third device 3 which is a portable internet device (such as a mobile phone or a tablet). The application software is connected to the detection unit 11 of the first device 1 correspondingly through the wireless connection and is also connected to the second device 2 via the wireless network for processing and analyzing the detected data from the detection unit 11. The data analysis unit 22 and the data processing unit 23 are used for data comparison and processing of the detected data received from the first device 1 to generate detection data of the brake fluid. Then the detection data of the brake fluid is retrieved from the second device 2 by the third device 3 through the wireless network and displayed on the third device 3 for users to view.

The wireless connection mentioned above can be one of the following ways: Bluetooth, Wi-Fi, etc. The wireless connection is defined as connection conducted by wireless modules. The connection is allowed, not necessarily through the internet. For example, the common wireless technologies include Bluetooth (BLE), Wi-Fi, and ZigBee, having short operating range from a few meters to a few hundred meters while LoRa is able to reach coverage ranges up to a few kilometers.

The wireless network mentioned above is a network in which a device and a carrier network/or internet are connected in a wireless way.

The data set by users is defined as the data being set by users who perform the operations on the operation interface 31 of the third device 3. For example, the data can be the type of the brake fluid, the brand of the brake fluid or others related to the brake fluid.

The brake fluid related data is defined as data collected through experiments by brake fluid manufacturers. The brake fluid brake fluid related data is stored in the data storage unit 21 of the second device 2 and retrieved by the data analysis unit 22 and the data processing unit 23 for data comparison and processing. Users are unable to access the brake fluid related data. The experiments are conducted by the manufacturers and the experimental data are saved in the data storage unit 21. The brake fluid related data remains unchanged unless an update is performed.

The detection data is defined as the detection results obtained after the data detected being processed by the second device 2.

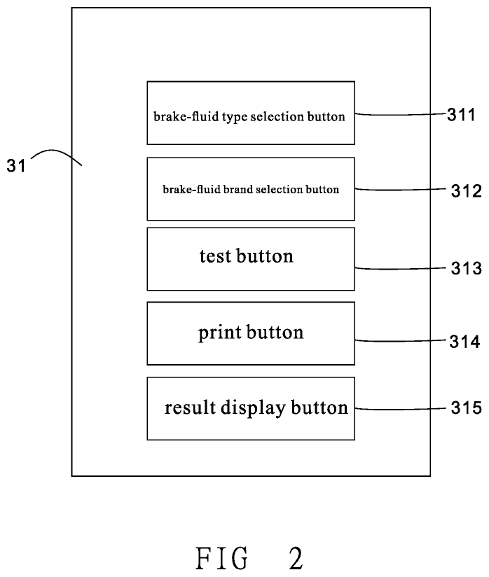

As shown in FIG. 2, the operation interface 31 of the third device 3 is revealed. A brake-fluid type selection button 311, a brake-fluid brand selection button 312, a test button 313, a print button 314 and a result display button 315 are disposed on the operation interface 31. The operation interface 31 of the applications software is corresponding and connected to the first device 1. When a detection of the brake fluid is carried out at the user end, a wireless connection is established between the operation interface 31 and the first device 1. Then the detection procedure is performed and the detection results are displayed through the operation interface 31. Thereby users can perform the operation quickly and get the detailed detection data of the brake fluid.

While in use, users press the brake-fluid type selection button 311 and the brake-fluid brand selection button 312 on the operation interface 31 for selecting the type and the brand of the brake fluid to be detected. This is the data set by users. Then insert the detection unit 11 of the first device 1 into the fluid tank and press the test bottom 313 on the operation interface 31 of the third device 3 to command the circuit of the detection unit 11 of the first device 1 to obtain the detected data of the oil product. Next the detection unit 11 sends the detected data of the brake fluid to the wireless communication module 12 of the data transmission unit and then the wireless communication module 12 transmits the detected data to the third device 3 through the wireless connection. The third device 3 is connected to the second device 2 via the wireless network so that the detected data and the data set by users are sent to the second device 2 for data processing. Then the result display button 315 is pressed to send commands to the second device 2 to get the detection data after processing. Lastly the third device 3 displays the detection data. The user presses the print button 314 to output the detection data by printing if he/she wants to print the data.

The brake fluid related data in the second device 2 includes a comparison database in which data are collected and generated by the experiments or data for comparison which has been established according to international standards. The comparison database is maintained and updated by the brake fluid manufacturers or their dealers. After receiving the detected data and the data set by users from the third device, the cloud database performs data comparison and processing of the detected data according to the data set by users. The data comparison process includes some operations such as conversion of the data or the units, comparison of the value and determination of the results. Once the results come out, the cloud database sends the results back to the third device 3 and the results are the detection data through the network.

The conventional detection system has the shortcomings such as poor portability and limited storage capacity of the brake fluid related data. The present system solves these problems by the cloud database for analyzing the brake fluid related data, the wireless network through which the third device 3 retrieves the detection data obtained after analysis, and the third device 3 on which the operations are performed and the detection data is displayed. Without any data update process, clients can get access to the most up-to-date data at all times. The volume of the detection end can also be decreased so that not only the cost is reduced, the clients can also move the detection end of the system for detecting the brake fluid freely.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A brake fluid detection system comprising:
a first device having
a detection unit which is a probe arranged with a sensing circuit and in direct contact with a brake fluid to be detected for sensing changes in water content or temperature of the brake fluid;
a transmission unit which is connected to the detection unit and is provided with a wireless communication module for providing a wireless connection and sending detected data from the detection unit;
a second device which is a cloud database including
a data storage unit, a data analysis unit, and a data processing unit;
a third device which is a portable internet device provided with an application software for receiving and displaying data of the brake fluid after detection; the application software having an operation interface;
wherein the wireless communication module receives detected data obtained through the detection in the fluid tank by the detection unit and sends the detected data to the third device through wireless connection; then the detection data is further transmitted to the second device through the third device for data extraction and processing;
wherein by operating the operation interface, the third device is connected to the first device and the second device correspondingly via the wireless network; the third device is used for data transmission and operation between the first device and the second device as well as data display; the operation interface of the third device is interactively connected to the detection unit of the first device for getting the detected data and is operated for sending the detected data to the second device; wherein brake fluid related data has been set and stored in the data storage unit of the second device in advance; the brake fluid related data includes types of the brake fluid, oil companies, experimental data for the respective brake fluids, and water content; the data analysis unit retrieves the brake fluid related data in the data storage unit for analysis and then the data processing unit generates detection data; next the detection data is obtained by and displayed on the third device so that users can read the detection data in a real-time manner.

2. The system as claimed in claim 1, wherein the operation interface of the third device is provided with a brake-fluid type selection button, a brake-fluid brand selection button, a test button, a print button and a result display button.
